(19) United States
(12) Patent Application Publication
(10) Pub. No.: US 2024/0322456 A1
(43) Pub. Date: Sep. 26, 2024

(54) Dual-Polarized Antenna

(71) Applicant: Guangzhou Sigtenna Technology Co., Ltd., Guangzhou (CN)

(72) Inventors: Taranenko Vladimir, Guangzhou (CN); Zimeng Li, Guangzhou (CN); Victor Aleksandrovich Sledkov, Guangzhou (CN)

(21) Appl. No.: 18/733,833

(22) Filed: Jun. 4, 2024

Related U.S. Application Data
(63) Continuation of application No. PCT/CN2021/137141, filed on Dec. 10, 2021.

(30) Foreign Application Priority Data
Dec. 6, 2021 (CN) 202111482267.5

(51) Int. Cl. H01Q 21/26; H01Q 1/50; H01Q 15/14; H01Q 25/00

(52) U.S. Cl. CPC H01Q 21/26; H01Q 1/50; H01Q 15/14; H01Q 25/001

(57) ABSTRACT

A dual-polarized antenna, including a radiating unit containing four conductive elements, four support elements, a feeding unit and a reflective plate, in which the four conductive elements are separated from each other by a cruciform slit at a middle of the radiating unit, top ends of the four support elements are connected to the conductive elements, and bottom ends of the four support elements are fixed on the reflective plate. The feeding element contains a PCB disposed at a middle of the radiating unit on top surfaces of the conductive elements and two coaxial cables disposed along the supporting elements and connected by its output conductors to a conductive layer covering a bottom surface of the PCB and connected by its input conductors to first ends of two strip lines disposed on a top surface of the PCB and forming two circuits matching the radiating unit with two coaxial cables.

### CROSS REFERENCE TO RELATED APPLICATIONS

The present application is a Continuation application of PCT Application No. PCT/CN2021/137141 filed on Dec. 10, 2021, which claims the benefit of Chinese Patent Application No. 202111482267.5 filed on Dec. 6, 2021. All the above are hereby incorporated by reference in their entirety.

### FIELD

The present disclosure relates to a dual-polarized antenna and, particularly, to an antenna emitting or receiving two orthogonal polarizations such as vertical and horizontal or +/−45-degree slants.

### BACKGROUND

In today's era of frequent use of mobile phones, the market has a huge demand for dual-polarized antennas. Therefore, considerable labor and material resources are invested in the art to develop an antenna that has specified beam widths and good cross polarization discrimination and is well matched with feeding cables through a wide frequency band. Additionally, these antennas are simple to be manufactured.

Due to crossed dipoles creating too wide beam at a horizontal plane, more complicated radiators were invented to decrease beam width. U.S. Pat. No. 5,940,044 describes a dual slant polarized antenna having an approximately 65 degrees half-power beam width in a horizontal plane. This antenna includes a plurality of dipole sub-arrays with each sub-array consisting of four dipoles arranged in a diamond shape. U.S. Pat. No. 6,333,720B1, U.S. Pat. No. 6,529,172B2 and US2010/0309084A1 contain figures of other radiators having a dipole square shape. Baluns of dipoles are tilted to the center of the dipole square to simplify manufacturing, but in spite of this new shape, these devices are still complicated in manufacturing.

U.S. Pat. No. 6,313,809B1 describes the dual-polarized radiator including four dipoles uniformly arranged above the reflector and forming a dipole square structurally in a top view. Other modifications of this dipole square are described in U.S. Pat. No. 6,940,465B2, U.S. Pat. No. 7,688,271B2, CN202423543U, CN202268481U, CN101916910A, CN102097677A, CN102694237A, CN102544711A, and CN102117967A.

The most of known dual-polarized radiators in a shape of a dipole square are excited by four coaxial cables soldered to radiators by their inner and outer conductors like dual-polarized antenna described by CN102013560A.

The first deficiency of the known dual-polarized antennas is a complicated feed network including four cables connecting four dipoles with a beam forming network usually placed on other side of a reflective plate. Couples of these cables are connected in parallel to another cable connected to a beam forming network. The second deficiency is restricted operating frequency band due to that feeding cables are connected to dipoles directly. Therefore, this antenna does not have a matching circuit between dipoles and feeding cables. Moreover, radiators made of aluminum have to be covered by a tin film for soldering cables. A need to use a tin plating process is the third deficiency, because the tin plating of big radiators increases cost of manufacturing.

### SUMMARY

An objective of the present disclosure is to overcome deficiencies of the prior art and other known dual-polarized antennas.

Starting from the prior art mentioned, a first objective of the present disclosure is to develop a wideband dual-polarized antenna with simple connection to a beam forming network. A second objective is to reduce the manufacturing cost of a large antenna operating at a frequency lower than 1 GHz. A third objective is to reduce the back radiation of the dual-polarized antenna.

Provided in the present disclosure is a dual-polarized antenna, including a radiating unit consisting of four conductive elements, four support elements, a feeding unit and a reflective plate, in which the four conductive elements are separated from each other by a cruciform slit at a middle of the radiating unit, top ends of the four support elements are directly connected with the conductive elements, and bottom ends of the four support elements are fixed on the reflective plate. The feeding unit includes a printed circuit board disposed at a middle of the radiating unit on top surfaces of the conductive elements and two coaxial cables disposed along the support elements and connected by its output conductors to a conductive layer covering a bottom surface of the printed circuit board and connected by its input conductors to the first ends of two strip lines disposed on a top surface of the printed circuit board and forming two circuits matching the radiating unit with two coaxial cables. The conductive layer covering a bottom surface of the printed circuit board includes a cruciform slit dividing the conductive layer into four parts disposed corresponding to four conductive elements of the radiating unit. The strip lines cross the cruciform slit at a center of the cruciform slit and second ends of strip lines are connected to coupling elements.

The reflective plate includes a cruciform slot disposed between bottom ends of the support elements.

FIGS. 1-15 show some embodiments of a dual-polarized antenna.

The dual-polarized antenna according to the present disclosure a wider frequency band in comparison with conventional solutions, with the result that the feeding unit includes a matching circuit connected between the radiating unit and a feeding coaxial cable. Therefore, it is possible to better match the dual-polarized antenna with feeding coaxial cables through a wide frequency band by adjusting dimensions of strip lines forming the matching circuit.

The dual-polarized antenna according to the present disclosure provide less back radiation in comparison with conventional solutions, with the result that a cruciform slot made in the reflective plate between bottom ends of the support elements creates additional radiation in a back direction suppressing back radiation created by the radiating unit.

### BRIEF DESCRIPTION OF THE DRAWINGS

FIG. 1 is a side view of a first embodiment of the dual-polarized antenna according to the present disclosure, in which the radiating unit consists of two crossed dipoles excited by the feeding unit disposed on a top surface of dipole's arms disposed on support elements above the reflective plate.

FIG. 2 is a side view of a part of the dual-polarized antenna shown in FIG. 1.

FIG. 3 is a side view of another shape of a dipole's arm and a support element.

FIGS. 4a-4f are top and bottom views, respectively, of a printed circuit board, including strip lines forming a matching circuit and the coupling element of different kinds.

FIG. 5 is a side view of another embodiment of the dual-polarized antenna, in which each arm of the crossed dipoles consists of two side portions and a middle portion connected to the side portions. The conductive reflecting plate contains a cruciform slot disposed between support elements.

FIG. 6 is a side view of another embodiment of the dual-polarized antenna, in which each arm of the crossed dipoles consists of two side portions connected to the support element and a middle portion separated from the side portions by dielectric films.

FIG. 7 is a side view of another embodiment of the dual-polarized antenna, in which the radiating unit consists of four dipoles arranged in a shape of a dipole square and connected to symmetrical lines formed by conductors connected to adjacent support elements and excited by a feeding unit.

FIG. 8 is a side view of another embodiment of the dual-polarized antenna, in which arms of dipoles arranged in a shape of a dipole square are tilted from a plane where the symmetrical lines are disposed towards the reflective plate.

FIG. 9 is a side view of another embodiment of the dual-polarized antenna, in which arms of dipoles arranged in a shape of a dipole square are tilted from a plane where the symmetrical lines are disposed to be directed away from the reflective plate.

FIG. 10 is a side view of another embodiment of the dual-polarized antenna, in which arms of each dipole fed by a symmetrical line are bent to be directed away from the reflective plate and towards a center of the radiating unit.

FIG. 11 is a side view of a part of radiating unit shown in FIG. 10, which is made of a piece of a metal sheet.

FIG. 12 is a side view of another embodiment of the dual-polarized antenna, in which the radiating unit consists of four folded dipoles arranged in a shape of dipole square and connected to symmetrical lines excited by a feeding unit.

FIG. 13 is a side view of another embodiment of the dual-polarized antenna, in which conductors connecting ends of the folded dipoles are tilted from a plane where the symmetrical lines are disposed towards the reflecting conductive plate.

FIG. 14 is a side view of another embodiment of the dual-polarized antenna, in which the folded dipoles include dielectric members and are tilted from a plane where the symmetrical lines are disposed to be directed away from the reflective plate.

FIG. 15 is a side view of another embodiment of the dual-polarized antenna, in which the support elements and the radiating unit including four folded dipoles are made of a piece of a metal sheet.

### DETAILED DESCRIPTION OF THE EMBODIMENTS

The accompanying drawings, which are incorporated in and constitute part of the specification, illustrate embodiments of the present disclosure and together with the general description of the present disclosure given below, and serve to explain the principles of the present disclosure.

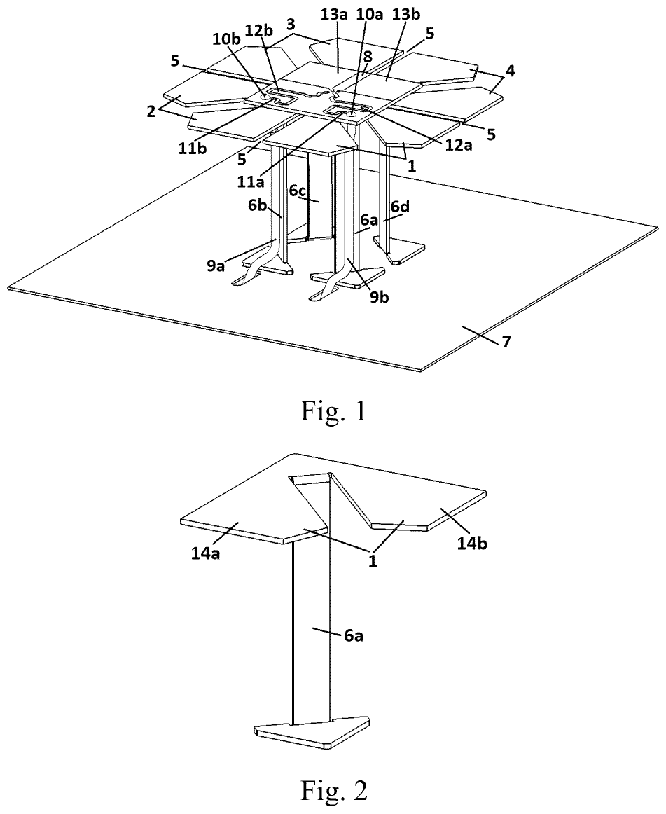

FIG. 1 is a side view of a first embodiment of the dual-polarized antenna of the present disclosure. Provided in the present disclosure is a dual-polarized antenna including a radiating unit, in which the radiating unit includes four conductive elements 1-4 separated from each other by a cruciform slit 5 at a middle of the radiating unit, four support elements 6a-6d directly connected with the conductive elements by its top ends and fixed on a reflective plate 7 by its bottom ends and a feeding unit. The feeding unit consists of a printed circuit board 8 disposed at a middle of the radiating unit on top surfaces of the conductive elements 1-4 and two coaxial cables 9a and 9b disposed along the support elements 6a and 6b and connected by its outer conductors to a conductive layer covering a bottom surface of the printed circuit board 8. Inner conductors 10a and 10b of coaxial cables 9a and 9b are connected to first ends 11a and 11b of strip conductors 12a and 12b disposed on a top surface of the printed circuit board 8 and forming two circuits matching the radiating unit with coaxial cables 9a and 9b. Coupling elements 13a and 13b create capacitive coupling between second ends of strip conductors 12a and 12b and conductive element 3. Therefore, a first radiating unit formed by the conductive elements 1 and 3 radiates an electromagnetic wave when the coaxial cable 9a excited. E vector of a first electromagnetic wave radiated is directed along an arrow Ea. A second radiating unit formed by the conductive elements 2 and 4 radiates electromagnetic wave when the coaxial cable 9b excited. E vector of a second electromagnetic wave radiated is directed along an arrow Eb and perpendicular to an arrow Ea. Thus, the dual-polarized antenna according to the present disclosure radiates two electromagnetic waves having orthogonal polarizations.

A shape of a radiated beam depends of a shape of a radiating unit. The provided dual-polarized antenna may include radiating units of different kinds. The conductive elements 1-4 shown in FIG. 1 form two crossed dipoles. The support elements 6a-6d form two crossed baluns of these dipoles. The support element 6a made as one portion with the dipole's arm 1 are shown in FIG. 2 where dipole's arm 1 consists of two side portions 14a and 14b.

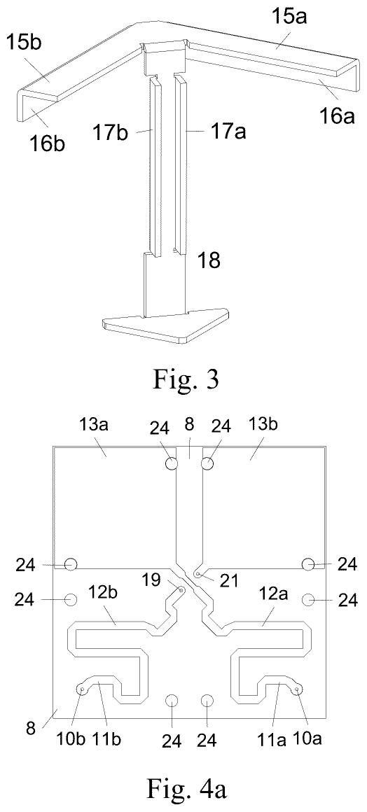

Another shape of a dipole's arm and a support element is shown in FIG. 3 where side portions 15a and 15b have a straight shape. Portions 16a and 16b at their edges are bent down to increase coupling between arms of crossed dipoles. Portions 17a and 17b at edges of a support element 18 are bent to increase coupling with the coaxial cable disposed along the support element 18 and increase suppression of a leaking wave spreading along an outer conductor of the coaxial cable. Crossed dipoles having arms of such shape could be used as low band radiating elements of dual band antennas so as to provide room between low band and high band radiating elements.

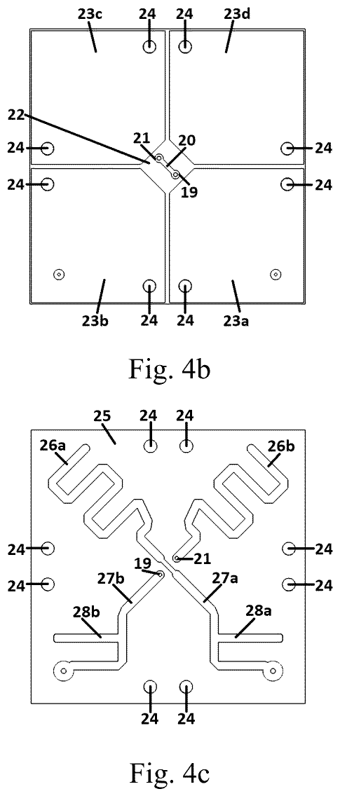

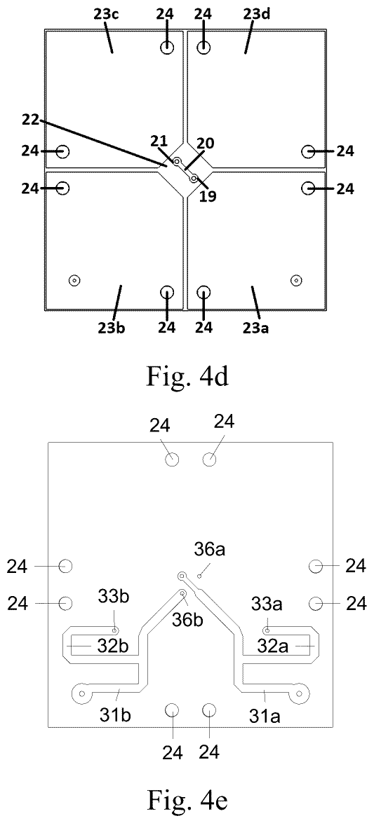

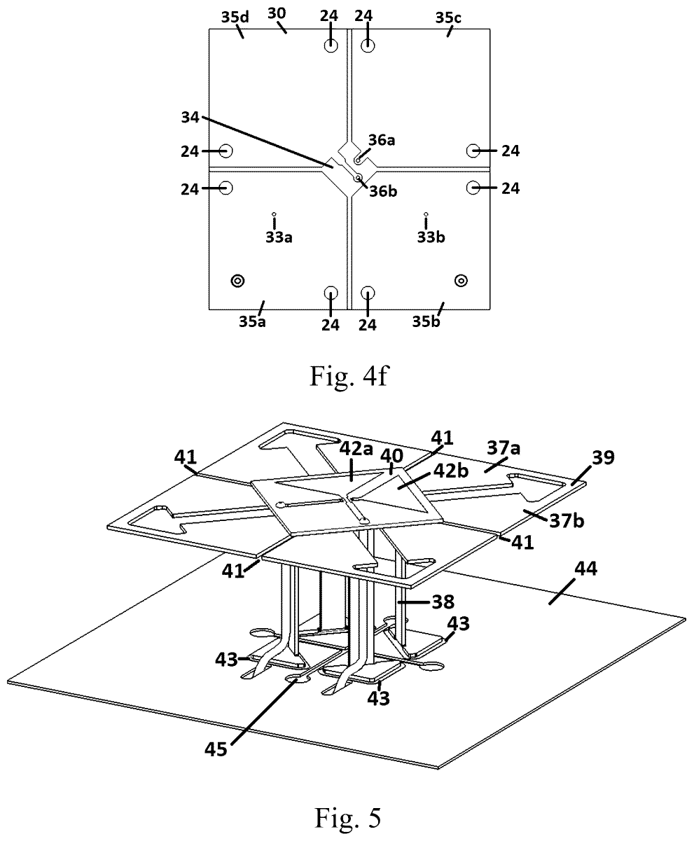

FIGS. 4a and 4b are top and bottom views accordingly of the printed circuit board 8 shown in FIG. 1. Strip conductors 12a and 12b disposed at a top surface of the printed circuit board 8 form coupling elements 13a and 13b in a shape of a rectangular plate and two matching circuits. A metallized hole 19 connects the strip conductor 12b to a strip conductor 20 disposed at a bottom surface of the printed circuit board 8. A metallized hole 21 connects the strip conductor 20 to the coupling elements 13b. The conductive layer covering a bottom surface of the printed circuit board contains a cruciform slit 22 dividing the conductive layer into four parts 23a-23d disposed corresponding to four conductive elements 1-4 accordingly. The strip conductor 20 is disposed at a center of the cruciform slit 22. Branches of the cruciform slit 22 are disposed corresponding to branches of the cruciform slit 5. The printed circuit board 8 is fixed to the conductive elements 1-4 by plastic screws or rivets (not shown) disposed in holes 24.

The impedance of a radiating unit depends on its shape and operational frequency band. Therefore, strip conductors forming matching circuits and coupling elements of different radiating units have different configurations and may include different elements.

FIGS. 4c and 4d are top and bottom views accordingly of another embodiment of the present disclosure where the printed circuit board 25 including coupling elements 26a and 26b in a shape of an open-ended stub creating a short circuit nearby a cruciform slit 22. Coupling elements 26a and 26b connect strip conductors 27a and 27b with portions 23d and 23c accordingly of the conductive layer covering a bottom surface of the printed circuit board 25. Such frequency dependent connection creates a pole of attenuation at higher frequency. Short open-ended stubs 28a and 28b acts as matching element through operational frequency band and create poles of attenuation at higher frequency. Therefore, coupling elements 26a and 26b and open-ended stubs 28a and 28b may form a filter suppressing radiation of electromagnetic waves of frequency band about two times higher than an operational frequency band. Therefore, such configuration of the matching circuit may be used for low band radiators of dual band antennas.

FIGS. 4e and 4f are top and bottom views accordingly of another embodiment of the present disclosure where the printed circuit boards 30 where strip conductors 31a and 31b form matching circuits including short-ended stubs 32a and 32b. A cruciform slit 34 splits the conductive layer into four portions 35a-35d. Metallized holes 33a and 33b connect ends of stubs 32a and 32b to portions 35a and 35b accordingly. Inner conductors of coaxial cables are connected to first ends of strip conductors 31a and 31b. Coupling elements in a shape of metallized holes 36a and 36b connect second ends of strip conductors to portions 35c and 35d accordingly. Outer conductors of coaxial cables are connected to portions 35a and 35b.

The matching circuit may contain other elements also to match different radiating unit with feeding coaxial cables. The provided dual-polarized antenna is well matched with feeding coaxial cables with the result that it is connected directly to the printed board circuit including power dividers, filters and other elements of a matching circuit. Dimensions of a dielectric substrate may be increased to add more elements in the matching circuit.

FIG. 5 is a side view of another embodiment of the dual-polarized antenna, in which each arm of the crossed dipoles consists of two side portions 37a and 37b connected to the support element 38 and a middle portion 39 connected to the side portions 37a and 37b. The matching of the dipole with the middle portion 39 to the coaxial cable is superior to that of the dipole without a middle portion to the coaxial cable as shown in FIGS. 1-3. Dimensions of printed circuit boards 40 are bigger, compared with dimensions of a printed circuit board 8 and its corners are disposed at opposite branches of a cruciform slit 41. Coupling elements 42a and 42b have a shape of a triangle. Dielectric films 43 are disposed between the bottom ends of the support elements 38 and the reflective plate to prevent generation of passive intermodulation products. A reflective plate 44 includes a cruciform slot 45 disposed between bottom ends of the support elements. The cruciform slot 45 excited by the support elements creates additional radiation in a back direction. Such a radiation has different phase compared with a radiation from the radiating unit spreading back around a reflective plate 44. Therefore, radiation from the cruciform slot 45 partly suppress a back radiation created by the radiating unit and improve anterior-posterior ratios of the provided dual-polarized antenna.

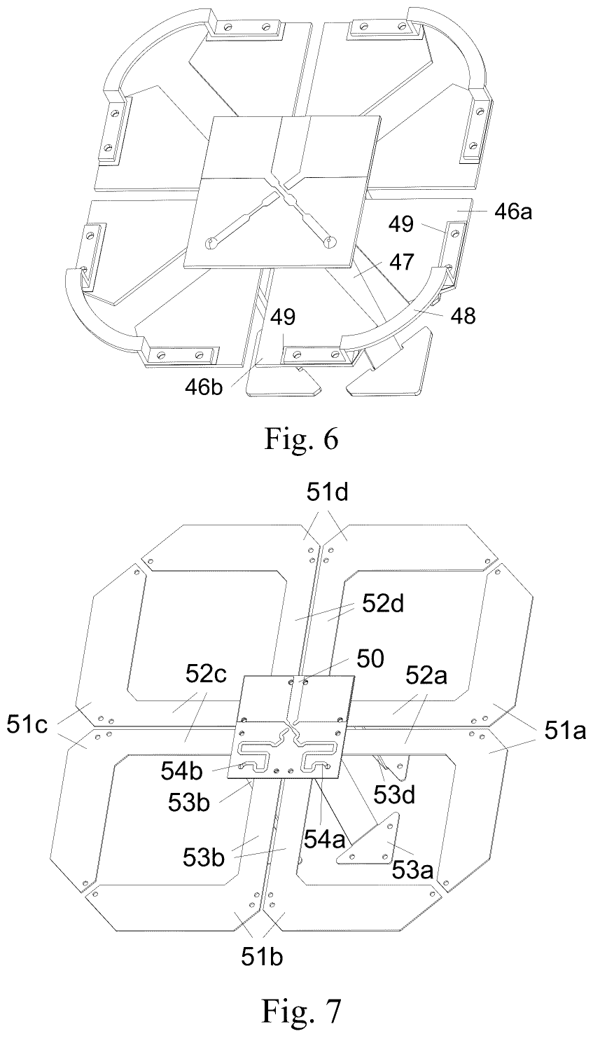

FIG. 6 is a side view of another embodiment of the dual-polarized antenna, in which each arm of the crossed dipoles consists of two side portions 46a and 46b connected to the supporting element 47 and an additional middle portion 48 made as a separate element separated from the side portions by dielectric films 49. Such a shape of the middle portion does not restrict lengths of support elements 47 as the middle portion 39 shown in FIG. 5. Therefore, support elements 47 of FIG. 6 may be longer. Crossed dipoles disposed higher above a reflective plate provide wider beam width and better matching with feeding coaxial cables.

FIG. 7 is a side view of another embodiment of the dual-polarized antenna, in which a printed board circuit 50 is disposed at a middle of the radiating unit consisting of four dipoles 51a-51d arranged in a shape of a dipole square and connected to symmetrical lines 52a-52d formed by conductors connected to adjacent supporting elements 53a-53d. The symmetrical lines 52a-52d are portions of a matching circuit formed on a printed board circuit 50. Feeding coaxial cables (not shown) are connected to strip conductors 54a and 54b disposed on a top surface of the printed board circuit 50. The radiating unit in a shape of dipole square provides narrower beam width. Therefore, such an antenna provides more gain compared with the crossed dipoles.

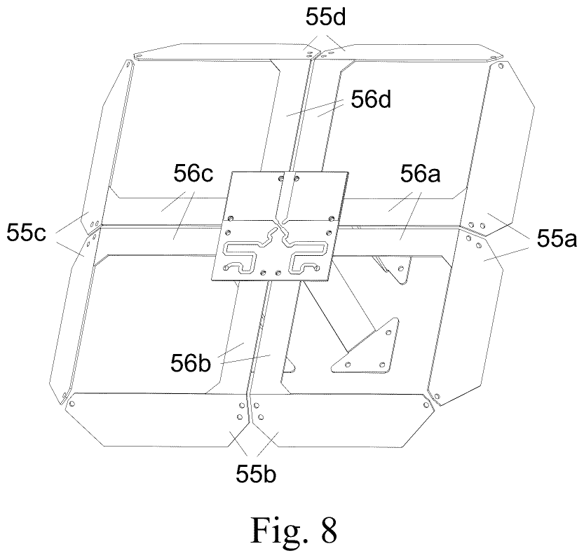

FIG. 8 is a side view of another embodiment of the dual-polarized antenna, in which arms of dipoles 55a-55d arranged in a shape of a dipole square are tilted from a plane where the symmetrical lines 56a-56d are disposed towards the reflective plate. Such tilting of dipoles 55a-55d increases gain and improves anterior-posterior ratios of the dual-polarized antenna.

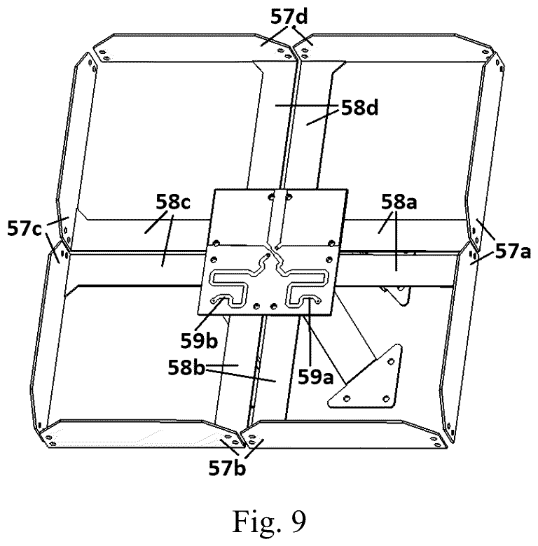

FIG. 9 is a side view of another embodiment of the dual-polarized antenna, in which arms of dipoles 57a-57d arranged in a shape of a dipole square are bent at 90 degrees from a plane where the symmetrical lines 58a-58d are disposed towards the reflective plate. Such a shape increases lengths of symmetrical lines 58a-58d and a distance between dipoles 57a-57d and a reflective plate improving matching of the dual-polarized antenna with coaxial cables (not shown) connected to strip conductors 59a and 59b.

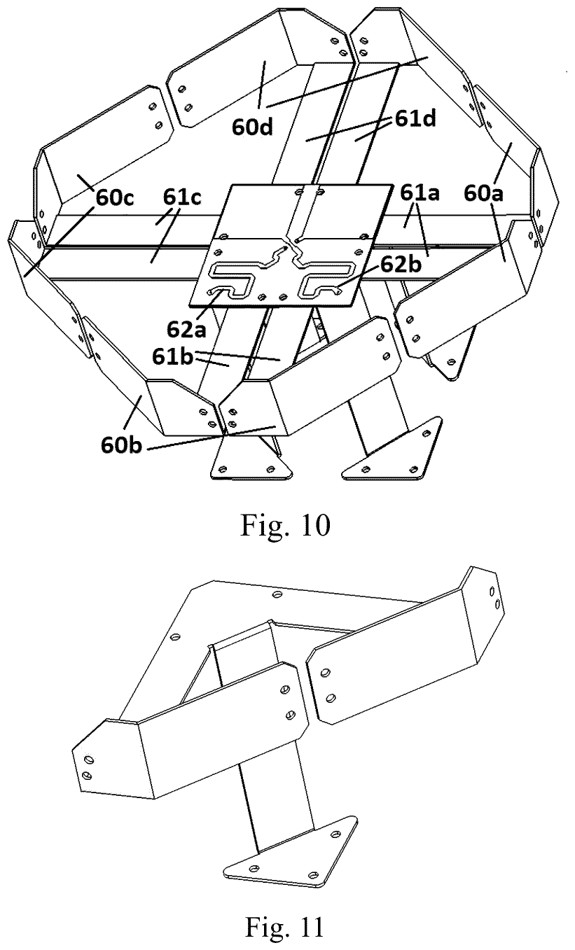

FIG. 10 is a side view of another embodiment of the dual-polarized antenna, in which arms of dipoles 60a-60d are bent at 90 degrees from a plane where the symmetrical lines 61a-61d are disposed to be directed away from the reflective plate and towards a center of the radiating unit. The outer contour of such radiating unit looks like an octagon. Such a shape increases lengths of symmetrical lines 61a-61d and a distance between dipoles 60a-60d and a reflective plate improving matching of the dual-polarized antenna with coaxial cables (not shown) connected to strip conductors 62a and 62b.

FIG. 11 is a side view of one portion of the radiating unit shown in FIG. 10. This portion may be made of a piece of a metal sheet by stamping. Therefore, manufacturing of such a dual-polarized antenna is cheap.

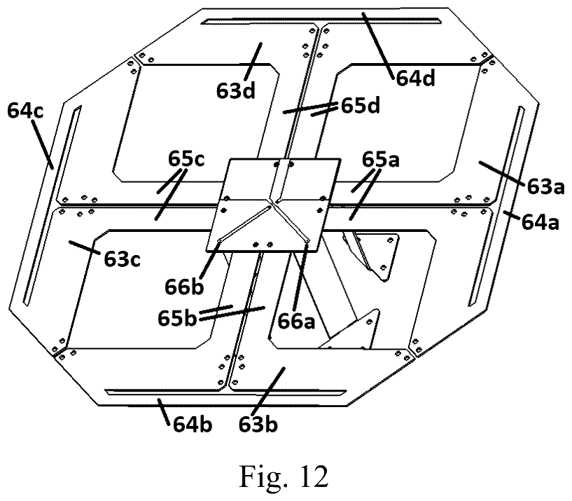

FIG. 12 is a side view of another embodiment of the dual-polarized antenna, in which the radiating unit consists of four folded dipoles 63a-63d arranged in a shape of dipole square and connected to symmetrical lines excited by a feeding unit. Strips 64a-64d connecting ends of the folded dipoles increase impedances of dipoles. Therefore, symmetrical lines 65a-65d feeding the folded dipoles have a bigger impedance compared with symmetrical lines feeding usual dipoles shown in FIGS. 7-10. A gap between their conductors is bigger. Therefore, impedance less dependent from production tolerances. Coaxial cables (not shown) are connected to strip conductors 66a and 66b to form the matching circuit together with symmetrical lines 65a-65d.

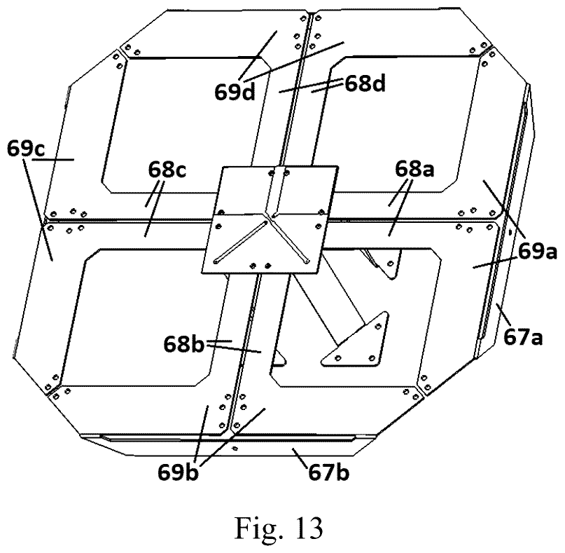

FIG. 13 is a side view of another embodiment of the dual-polarized antenna, in which strips 67a-67d connecting ends of the folded dipoles are tilted from a plane where the symmetrical lines 68a-68d and dipoles 69a-69d are disposed towards the reflective plate. The radiating unit with tilted strips 67a-67d is more robust and has smaller dimensions than the flat radiating unit shown in FIG. 12.

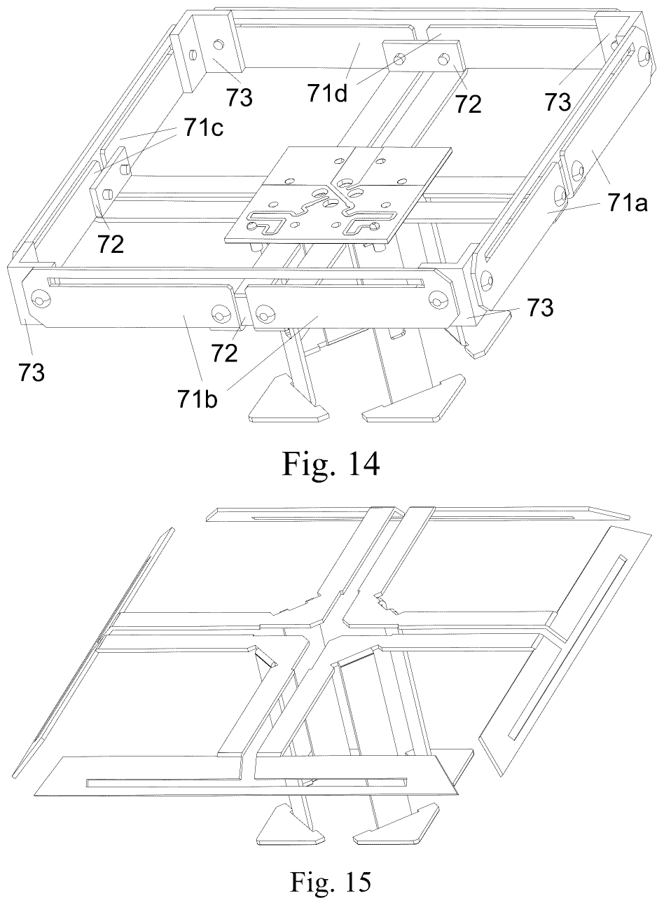

FIG. 14 is a side view of another embodiment of the dual-polarized antenna, in which the folded dipoles 71a-71d are tilted from a plane where the symmetrical lines are disposed to be directed away from the reflective plate. Dielectric members 72 are disposed between arms of folded dipoles 71a-71d and dielectric members 73 are disposed between ends of adjacent folded dipoles to keep dimensions of symmetrical lines and increase durability of the radiating unit.

FIG. 15 is a side view of another embodiment of the dual-polarized antenna, in which the support elements and the radiating unit including four folded dipoles are made of a piece of a metal sheet by stamping. The folded dipoles are tilted from a plane where the symmetrical lines are disposed to be directed towards the reflective plate to improve anterior-posterior ratios and increase gain.

Radiating units having different shapes provide different radiating patterns. Therefore, the dual-polarized antennas according to the present disclosure may be used for creating different antenna arrays.

The dual-polarized antennas according to the present disclosure provide a wider frequency band in comparison with conventional solutions, with the result that the feeding unit includes a matching circuit connected between the radiating unit and a feeding coaxial cable. Therefore, it is possible to better match the dual-polarized antenna with feeding coaxial cables through the wide frequency band by adjusting dimensions of strip lines forming the matching circuit.

The manufacturing cost of the dual-polarized antennas according to the present disclosure is less in comparison with conventional solutions, with the result that all elements of the radiating unit and supporting elements do not need tin plating and may be made of aluminum sheet by stamping.

The dual-polarized antennas according to the present disclosure provide less back radiation in comparison with conventional solutions, with the result that a cruciform slot made in the reflective plate between the bottom ends of the support elements creates additional radiation in a back direction suppressing back radiation created by the radiating unit.

While the present disclosure has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the present disclosure in its broader aspects is not limited to the specific details, representative devices, and illustrative examples shown and described. Accordingly, departures may be made from such details without departing from the spirit or scope of the Applicant's general inventive concept.

1. A dual-polarized antenna, comprising a radiating unit consisting of four conductive elements, four support elements, a feeding unit, and a reflective plate,
wherein the four conductive elements are separated from each other by a cruciform slit at a middle of the radiating unit, top ends of the four support elements are directly connected to the conductive elements, and bottoms of the four support elements are fixed on the reflective plate;
wherein the feeding unit consists of a printed circuit board disposed at a middle of the radiating unit on top surfaces of the conductive elements and two coaxial cables disposed along the support elements and connected by its outer conductors to a conductive layer covering a bottom surface of the printed circuit board and connected by its inner conductors to first ends of two strip lines disposed on a top surface of the printed circuit board and forming two circuits matching the radiating unit with two coaxial cables;
wherein the conductive layer covering a bottom surface of the printed circuit board comprises a cruciform slit dividing the conductive layer into four parts disposed corresponding to four conductive elements of the radiating unit; and
wherein the strip lines cross the cruciform slit at a center of the cruciform slit and second ends of strip lines are connected to coupling elements.

2. The dual-polarized antenna according to claim 1, wherein the matching circuit comprises open-ended stubs and short-ended stubs.

3. The dual-polarized antenna according to claim 1, wherein one portion of the strip line crossing the cruciform slit formed in the conductive layer is disposed on a bottom surface of the printed circuit board and connected to the strip line by metallized holes made in the printed circuit board.

4. The dual-polarized antenna according to claim 1, wherein the coupling elements have a shape of conductive plates formed on a top surface of the printed circuit board.

5. The dual-polarized antenna according to claim 1, wherein the coupling elements have a shape of strip lines with open ends.

6. The dual-polarized antenna according to claim 1, wherein the coupling elements have a shape of metallized holes made in the printed circuit board.

7. The dual-polarized antenna according to claim 1, wherein the reflective plate contains a cruciform slot disposed between bottom ends of the support elements.

8. The dual-polarized antenna according to claim 1, wherein the radiating unit consists of two crossed dipoles.

9. The dual-polarized antenna according to claim 8, wherein each arm of the crossed dipoles consists of two side portions connected to the support element.

10. The dual-polarized antenna according to claim 8, wherein each arm of the crossed dipoles consists of two side portions connected to the support element and a middle portion connected to the side portions.

11. The dual-polarized antenna according to claim 1, wherein the radiating unit comprises four dipoles placed above the reflective plate and arranged in a shape of a dipole square.

12. The dual-polarized antenna according to claim 11, wherein each dipole is connected to a symmetrical line formed by two conductors connected to adjacent support elements.

13. The dual-polarized antenna according to claim 12, wherein the dipoles are disposed in a same plane with the symmetrical lines.

14. The dual-polarized antenna according to claim 12, wherein the dipoles are tilted at 30-90 degrees from a plane where the symmetrical lines are disposed towards the reflective plate.

15. The dual-polarized antenna according to claim 12, wherein the dipoles are tilted at 30-90 degrees from a plane where the symmetrical lines are disposed away from the reflective plate.

16. The dual-polarized antenna according to claim 11, wherein arms of each dipole are bent towards a center of the radiating unit.

17. The dual-polarized antenna according to claim 1, wherein the radiating unit comprises four folded dipoles placed above a reflective plate and arranged in a shape of a dipole square.

18. The dual-polarized antenna according to claim 17, wherein each folded dipole is connected to a symmetrical line formed by two conductors connected to adjacent support elements.

19. The dual-polarized antenna according to claim 18, wherein each folded dipole is disposed in a same plane with the symmetrical lines.

20. The dual-polarized antenna according to claim 18, wherein conductors connecting ends of the folded dipoles are tilted from a plane where the symmetrical lines are disposed to be directed towards the reflective plate.

21. The dual-polarized antenna according to claim 18, wherein the folded dipoles are tilted at 30-90 degrees from a plane where the symmetrical lines are disposed to be directed towards the reflective plate.

22. The dual-polarized antenna according to claim 18, wherein the folded dipoles are tilted at 30-90 degrees from a plane where the symmetrical lines are disposed to be directed away from the reflective plate.
